(19) United States
(12) Patent Application Publication
(10) Pub. No.: US 2012/0163167 A1
(43) Pub. Date: Jun. 28, 2012

(54) TRANSMISSION CONTROL PROTOCOL OPTIMIZATION SYSTEMS AND METHODS FOR WIRELESS NETWORKS

(75) Inventor: Nicolas S. Dade, Santa Cruz, CA (US)

(73) Assignee: SYMBOL TECHNOLOGIES, INC., Schaumburg, IL (US)

(21) Appl. No.: 12/978,893

(22) Filed: Dec. 27, 2010

(51) Int. Cl. H04L 12/26

(52) U.S. Cl. 370/229

(57) ABSTRACT

The present disclosure provides systems and methods improving Transmission Control Protocol (TCP) network congestion avoidance in wireless networks. Specifically, the present disclosure decouples wired and wireless TCP connections at a wireless access point, thin access point, wireless switch, etc. The wired TCP session is terminated on the wireless access device and a wireless TCP session is automatically started for the last hop to a mobile unit. Advantageously, the wireless TCP session may utilize a congestion avoidance algorithm optimized for wireless network. Furthermore, wireless local area network (WLAN) information may be tied to the TCP stack for improved performed, e.g. an IEEE 802.11 Acknowledgement (ACK) may be considered as equivalent to a TCP ACK from the mobile unit. By splitting a TCP downstream connection into two—wireless and wired, high-jitter, high-loss wireless hops may be hidden from the remote host's TCP socket.

### FIELD OF THE INVENTION

The present invention relates generally to wireless networks. More particularly, the present invention provides Transmission Control Protocol (TCP) optimization systems and methods that decouple wired and wireless TCP connections at a wireless access device.

### BACKGROUND OF THE INVENTION

Transmission Control Protocol (TCP) uses a network congestion avoidance algorithm that includes various aspects, schemes, techniques, etc. in order to achieve congestion avoidance. TCP Veno was designed to eliminate the outstanding problem that TCP performance is degraded significantly by random loss in wireless networks, i.e. to accurately distinguish congestion losses from random losses caused due to channel noise and interference. TCP Veno has been demonstrated to show better performance than TCP Reno in wired and wireless environments. TCP Westwood+ is a sender-side only modification of the TCP Reno protocol stack that optimizes the performance of TCP congestion control over both wired and wireless networks. TCP Westwood+ is based on end-to-end bandwidth estimation to set congestion window and slow start threshold after a congestion episode, that is, after three duplicate acknowledgments or a timeout. The bandwidth is estimated by properly low-pass filtering the rate of returning acknowledgment packets. The rationale of this strategy is simple: in contrast with TCP Reno, which blindly halves the congestion window after three duplicate Acknowledgments (ACKs), TCP Westwood+ adaptively sets a slow start threshold and a congestion window which takes into account the bandwidth used at the time congestion is experienced. TCP Westwood+ significantly increases throughput over wireless links and fairness compared to TCP Reno/NewReno in wired networks. Since TCP Westwood+ and Veno are optimized to handle congestion control for both wired and wireless network, they have difficulties in handling poor wireless conditions, e.g. low-signal strength, strong interference, etc. The characteristics (packet errors, packet delay, rate changes) of wireless networks are considerably different from wired networks. Typical TCP congestion algorithms such as Westwood+ and Veno are designed for multi-hop wired networks and are not optimized for wireless networks; rather they are erroneously misled by the behavior of wireless networks.

### BRIEF SUMMARY OF THE INVENTION

In an exemplary embodiment, a Transmission Control Protocol (TCP) optimization method includes operating a wireless access device communicatively coupled to a mobile device and a wired network; and, at the wireless access device, splitting TCP connections between the mobile device and the wired network into a wireless TCP connection and a wired TCP connection. The TCP optimization method may further include selectively enabling TCP connection optimization at the wireless access device, wherein the splitting TCP connections between the mobile device and the wired network may be performed if the TCP connection optimization is selectively enabled. Optionally, the splitting TCP connections between the mobile device and the wired network at the wireless access device may include terminating the TCP connection at a local socket; and opening up another TCP connection on another socket. Alternatively, the splitting TCP connections between the mobile device and the wired network at the wireless access device may include performing an in-line separation by buffering and resending between the wireless TCP connection and the wired TCP connection. The TCP optimization method may further include selectively enabling the in-line separation based upon conditions associated with a wireless link between the wireless access device and the mobile device. The TCP optimization method may further include utilizing a first TCP congestion control algorithm on the wired TCP connection; and utilizing a second TCP congestion control algorithm on the wireless TCP connection. Optionally, the first TCP congestion control algorithm may be different from the second TCP congestion control algorithm. The second TCP congestion control algorithm may include either TCP Westwood+ or Veno. The TCP optimization method may further include utilizing wireless local area network connection information between the mobile device and the wireless access device with the wireless TCP connection. The utilizing wireless local area networking connection information may include utilizing queuing associated with wireless local area networking in place of a TCP congestion control algorithm and utilizing wireless local area networking acknowledgements in place of TCP acknowledgements.

In another exemplary embodiment, a wireless access device includes a communication interface configured to communicate with one or more mobile devices wirelessly and with a wired network; and a processor coupled to the communication interface, wherein, for one or more TCP connections between one of the one or more mobile devices and the wired network, the processor is configured to split each of the one or more TCP connections into a wireless TCP connection and a wired TCP connection. Optionally, to split each of the one or more TCP connections, the processor may be configured to utilize separate sockets for the wireless TCP connection and the wired TCP connection. Alternatively, to split each of the one or more TCP connections, the processor may be configured to perform an in-line separation by buffering and resending between the wireless TCP connection and the wired TCP connection. The processor may be configured to selectively enable the in-line separation based upon conditions associated with a wireless link between the wireless access device and the mobile device. Optionally, the processor may be configured to utilize a first TCP congestion control algorithm on the wired TCP connection and a second TCP congestion control algorithm on the wireless TCP connection. The first TCP congestion control algorithm may be different from the second TCP congestion control algorithm. The second TCP congestion control algorithm may include either TCP Westwood+ or Veno. The processor may be configured to utilize wireless local area network connection information related to a wireless link to one of the one or more mobiles device with the wireless TCP connection. To utilize wireless local area network connection information, the processor may utilize queuing associated with wireless local area networking in place of a TCP congestion control algorithm and wireless local area networking acknowledgements in place of TCP acknowledgements.

In yet another exemplary embodiment, a network includes a wired network; a wireless network; and a wireless access device communicatively coupling the wired network and the wireless network therebetween; wherein the wireless access device is configured to implement Transmission Control Protocol (TCP) optimization algorithm between the wired network and the wireless network.

### BRIEF DESCRIPTION OF THE DRAWINGS

The present invention is illustrated and described herein with reference to the various drawings, in which like reference numbers denote like method steps and/or system components, respectively, and in which:

FIG. 1 is a network diagram of a wireless network with a plurality of wireless access devices and a wireless switch;

FIG. 2 is a block diagram of a wireless switch suitable for use in a network, such as in the wireless network of FIG. 1;

FIG. 3 is a block diagram of another wireless switch suitable for use in a network, such as in the wireless network of FIG. 1;

FIG. 4 is a network diagram of the wireless network of FIG. 1 with a chart showing TCP connections;

FIG. 5 is a flowchart of a TCP optimization method for separating a TCP connection between wireless and wired components; and

FIG. 6 is a flowchart of a TCP optimization method using TCP Acknowledgment (ACK) suppression over a wireless connection.

### DETAILED DESCRIPTION OF THE INVENTION

In various exemplary embodiments, the present invention provides systems and methods improving TCP network congestion avoidance in wireless networks. Specifically, the present invention decouples wired and wireless TCP connections at a wireless access point, thin access point, wireless switch, etc. that are collectively referred to as wireless access devices. The wired TCP session is terminated on the wireless access device and a wireless TCP session is automatically started for the last hop to a mobile unit. Advantageously, the wireless TCP session may utilize a congestion avoidance algorithm optimized for wireless network. Furthermore, wireless local area network (WLAN) information (e.g., IEEE 802.11) may be tied to the TCP stack for improved performed, e.g. an IEEE 802.11 Acknowledgement (ACK) may be considered as equivalent to a TCP ACK from the mobile unit with modifications to the IEEE 802.11 ACK. By splitting a TCP downstream connection into two—wireless and wired, high-jitter, high-loss wireless hops may be hidden from the remote host's TCP socket. Thus TCP's well-tuned-forwarded-networks behavior can be trusted to keep data flowing from the remote host to AP, while concurrently the AP can take care of getting the data to the wireless client on its own, using all the resources of IEEE 802.11 at its disposal, e.g. IEEE 802.11 queuing and IEEE 802.11 ACKs can effectively substitute for a TCP congestion scheduling algorithm and ACKs.

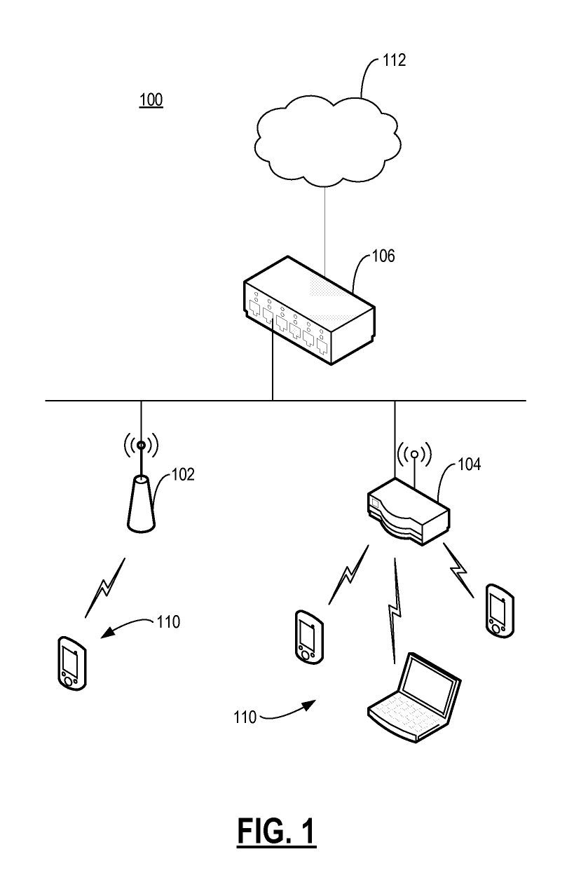

Referring to FIG. 1, in an exemplary embodiment, a wireless network 100 includes a plurality of wireless access devices 102, 104 and a wireless switch 106. In an exemplary embodiment, the plurality of wireless access devices 102, 104 are configured to support communications between and/or among mobile devices 110, and the wireless network 100 may include additional devices to support functionality of the wireless network 100, such as Ethernet switches, and the like which are not illustrated for simplicity. In this exemplary embodiment, the wireless access device 102 is an access port that cooperates with the wireless switch 106, i.e. the wireless access device 102 is referred to as a “thin” access port that relies on network intelligence and management functions provided by the wireless switch 106. The wireless access device 104 is a wireless access point (AP) that includes embedded processing capabilities that take the place of that normally provided by the wireless switch 106. Thus, the wireless access device 104 need not rely upon the wireless switch 106 for operation. Wireless access ports having conventional features that can be incorporated into the wireless access device 102, and wireless access points having conventional features that can be incorporated into the wireless access device 14 are available from Symbol Technologies, Inc.

Briefly, a wireless access device as described herein is suitably configured to receive data from wireless clients such as the mobile devices 110 over wireless links. Once that data is captured by the wireless access device 102, 104, the data can be processed for communication within the wireless network 100. For example, the data can be encapsulated into a packet format compliant with a suitable data communication protocol. In the example embodiment, data is routed within the wireless network 100 to a local network 112 using conventional Ethernet 802.3 addressing (including standard Ethernet destination and source packet addresses). It should be appreciated that the wireless switch 106 may not be used with the wireless access device 104, and that the features and/or functionality described below in the context of the wireless switch 106 may be equivalently incorporated into the wireless access device 104 in such embodiments that do not include a wireless switch 106.

The wireless switch 104 may be coupled to the local network 112, which in turn may be coupled to one or more additional components and/or computer networks, as will be understood. It should be understood that FIG. 1 is a simplified representation of the wireless network 100 for purposes of explanation. A practical embodiment may have any number of wireless switches 106, each supporting any number of wireless access devices 102, 104 and each wireless access device 102, 104 supporting any number of mobile devices 110. The topology and configuration of the wireless network 100 can vary to suit the needs of the particular application, and FIG. 1 is not intended to limit the application or scope of the subject matter in any way.

In an exemplary embodiment, the wireless network 100 is configured as a wireless local area network (WLAN). In alternative embodiments, the wireless network 100 may be configured as a wireless personal area network (WPAN), a wireless wide area network (WWAN), or any other suitable network configuration. The wireless network 100 may be configured to utilize a data communication protocol in accordance with IEEE 802.11, conventional Internet Protocol techniques, transmission control protocol/Internet protocol (TCP/IP), hypertext transfer protocol (HTTP), simple object access protocol (SOAP), or another comparable protocol. WLANs are generally defined in IEEE 802.11 standards and can operate over the unregulated 2.4 and 5 GHz frequency bands spectrum. WLAN vendors have committed to supporting a variety of standards such as IEEE 802.11a, 802.11b, 802.11g, 802.11i, 802.11n, and 802.1x. The various 802.11 standards developed by the IEEE are available for download via URL: standards.ieee.org/getieee802/802.11.html; these various standards are hereby incorporated by this reference herein.

In an exemplary embodiment, the wireless access devices 102, 104 are coupled to the wireless switch 106. Depending on the embodiment, the wireless access devices 102, 104 may be coupled to the wireless switch 106 via one or more additional access devices, wireless switches, Ethernet switches, routers, and/or various combinations thereof. In an exemplary embodiment, the wireless access devices 102, 104 are configured to receive data from mobile devices 110 over wireless data communication links. Once that data is captured by the wireless access device 102, the data may be encapsulated (e.g., into a packet format compliant with a suitable data communication protocol) for communication to another access device 102, 104, a mobile device 110, and/or the local network 112, as will be understood.

A mobile device 110 may be realized using any suitable platform, including, without limitation: a cellular telephone; a smart phone; a personal digital assistant (PDA); a digital media player (e.g., mp3 player); a portable video game device; a laptop or other portable computer; a tablet device; or the like. In an exemplary embodiment, a mobile device 110 is configured to periodically scan for wireless access devices 102, 104, and maintain a list and/or table of the access devices 102, 104 having a signal strength that indicates the mobile device 110 is within the communication range of the access device 102, 104. For example, a mobile device 110 may receive broadcast messages and/or beacon signals from access devices 102, 104 within communication range advertising their identity (e.g., service set identifier (SSID) or media access control (MAC) address). The mobile device 110 may then be configured to select an access device from the list of access devices within range, and send an association request to the selected access device. The mobile device 110 may automatically select the access device based on signal strength, in a random order, prompt a user for manually selecting an access device, or select an access device in some other manner. It should be appreciated that the functionality of the mobile device 110 will largely be dependent on the user, manufacturer, or vendor responsible for configuring and/or designing the mobile device, and the subject matter described herein is not limited to a specific manner of identifying an access device and making an association request.

In an exemplary embodiment, a mobile device 110 sends an association request, which may include information about the mobile device 110 (e.g., supported data rates, etc.) and the identity of the access device and/or network it wishes to associate with. In an exemplary embodiment, the access device 102 is configured to route the association request to the wireless switch 106 for analyzing and responding to the association request, as described in greater detail below. In general, the wireless switch 106 sends an association response containing an acceptance or rejection notice to the mobile device 110 requesting association via the access device 102. If the association is granted, the wireless switch 106 may also provide information regarding the association, such as supported data rates or association identification, as will be understood. Further, the wireless access device 104 may perform similar functions without requiring the wireless switch 106. The present invention generally relates to TCP optimization over wireless links, and may be utilized with the wireless access devices 102, 104 and the mobile devices 110. Those of ordinary skill in the art will recognize the present invention may be utilized with any wireless system and the wireless access devices 102, 104 are presented herein only as an illustration of an exemplary embodiment.

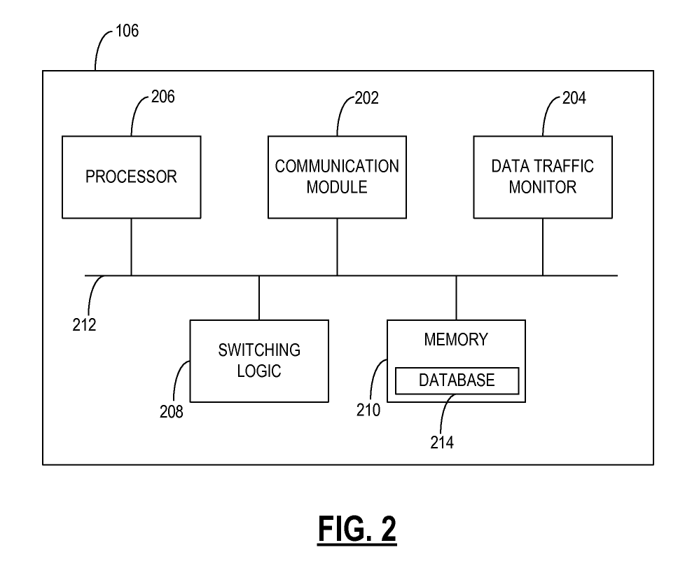

Referring to FIG. 2, in an exemplary embodiment, a block diagram illustrates is a schematic representation a wireless switch 106 suitable for use in a network, such as in the wireless network 100 of FIG. 1. In an exemplary embodiment, the wireless switch 106 may include, without limitation: a communication module 202, a data traffic monitor 204, a processor 206, switching logic 208, and a suitable amount of memory 210. The elements of the wireless switch 106 may be interconnected together using a bus 212 or another suitable interconnection arrangement that facilitates communication between the various elements of the wireless switch 106. It should be appreciated that FIG. 2 depicts the wireless switch 106 in an oversimplified manner, and a practical embodiment may include additional components and suitably configured processing logic to support known or conventional operating features that are not described in detail herein.

In an exemplary embodiment, the wireless switch 106 includes intelligence and processing logic that facilitates centralized control and management of WLAN elements, including wireless access devices (e.g., the wireless access device 102 in FIG. 1) associated with wireless switch 106. In an exemplary embodiment, one wireless switch 106 can support any number of wireless access devices (limited only by practical considerations). Thus, the wireless switch 106 can serve multiple wireless access devices, which in turn can serve multiple mobile devices. The wireless switch 106 is suitably configured to transmit and receive data, and it may serve as a point of interconnection between a WLAN and a wired (e.g., Ethernet) network. In practice, the number of the wireless switches 106 in a given network may vary depending on the number of network users and the physical size of the network. In another exemplary embodiment, the wireless switch 106 can include one or more wireless access devices 104 in the same device, e.g. this is typical of an AP configuration.

In an exemplary embodiment, the communication module 202 generally represents the hardware, software, firmware, processing logic, and/or other components of the wireless switch 106 that enable bi-directional communication between the wireless switch 106 and network components to which the wireless switch 106 is coupled. For example, referring to FIG. 1, the communication module 202 is suitably configured to communicate with components on the wireless network 100, such as the wireless access devices 102, 104 and/or the local network 106. The communication module 202 may provide an Ethernet interface such that the wireless switch 106 may communicate with a conventional Ethernet-based computer network. In this regard, the communication module 202 may include a physical interface for connection to the computer network, and the communication module 202 (and/or the processor 206) may handle Ethernet addressing for data packets sent from the wireless switch 106. For example, the physical interface may include an Ethernet card (e.g., 10BaseT, Fast Ethernet, Gigabit Ethernet) or the like with hardware, software, firmware, etc. configured to provide address, control, and/or data connections.

In an exemplary embodiment, the communication module 202 may support one or more wireless data communication protocols that are also supported by the wireless network infrastructure. Any number of suitable wireless data communication protocols, techniques, or methodologies may be supported by the communication module 202, including, without limitation: RF; IrDA (infrared); Bluetooth; ZigBee (and other variants of the IEEE 802.15 protocol); IEEE 802.11 (any variation); IEEE 802.16 (WiMAX or any other variation); Direct Sequence Spread Spectrum; Frequency Hopping Spread Spectrum; cellular/wireless/cordless telecommunication protocols; wireless home network communication protocols; paging network protocols; magnetic induction; satellite data communication protocols; wireless hospital or health care facility network protocols such as those operating in the Wireless Medical Telemetry Service (WMTS) bands; General Packet Radio Service (GPRS); and proprietary wireless data communication protocols such as variants of Wireless USB. In an exemplary embodiment, the communication module 202 is compliant with at least the IEEE 802.11 specification and variants thereof. The communication module 202 may include or be realized as hardware, software, and/or firmware, as will be appreciated in the art.

In an exemplary embodiment, the data traffic monitor 204 is configured to monitor the flow or amount of data processed by the wireless switch 106. Data traffic monitor 204 may be implemented or performed with the processor 206, a content addressable memory, a digital signal processor (DSP), an application specific integrated circuit (ASIC), a field programmable gate array (FPGA), any suitable programmable logic device, discrete gate or transistor logic, discrete hardware components, or any combination thereof, designed to perform the functions described below. In an exemplary embodiment, the data traffic monitor 204 monitors the throughput, data rate, data volume, packet count, an average data rate, an average data volume, or any quantity or characteristic based upon empirical or statistical information. The monitored data may be unidirectional or bidirectional, depending upon the specific application. In an exemplary embodiment, the data traffic monitor 204 is configured to monitor data and/or network traffic for the individual access devices. For example, the data traffic monitor 204 may implement a table (or list, cache, database or another suitable data structure) that maintains associations of the monitored data and/or statistics with the respective access device transmitting/receiving the data for those access devices associated with the wireless switch 106. The data traffic monitor 204 may be further configured to detect certain types of voice calls and to provide/maintain information about whether there is an active voice call on a particular mobile device 110. The data traffic monitor 204 may maintain trigger events when voice calls start and end such that this information may be used for dynamic load balancing. Note, in addition to voice calls, the data traffic monitor 204 may be able to infer other real-time applications in use by mobile devices 110 through the monitored data and/or statistics.

In an exemplary embodiment, the processor 206 may be implemented or realized with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this regard, the processor 206 may be realized as a microprocessor, a controller, a microcontroller, a state machine, or the like. The processor 206 may also be implemented as a combination of computing devices, e.g., a combination of a digital signal processor and a microprocessor, a plurality of microprocessors, one or more microprocessors in conjunction with a digital signal processor core, or any other such configuration. In practice, the processor 206 includes processing logic that may be configured to carry out the functions, techniques, and processing tasks associated with the operation of the wireless switch 106, as described in greater detail below. Furthermore, the steps of a method or algorithm described in connection with the embodiments disclosed herein may be embodied directly in hardware, in firmware, in a software module executed by the processor 206, or in any practical combination thereof.

In an exemplary embodiment, the switching logic 208, which may be partially or completely realized in the processor 206, represents processing logic and functionality associated with the data switching and communicating features of the wireless switch 106. The switching logic 208 may be configured to perform conventional operations that enable data traffic in the wireless network to be communicated between mobile devices, access devices, network infrastructure components, and network-based systems or applications. In an exemplary embodiment, the switching logic 208 and the processor 206 may be cooperatively configured to implement processing logic and functionality associated with the handling of TCP congestion control between the access device 102 and mobile devices 110, as described in greater detail below. In an exemplary embodiment, the memory 210 includes sufficient data storage capacity to support the operation of the wireless switch 106. Memory 210 may be realized as random access memory (RAM), flash memory, registers, a hard disk, a removable disk, or any other form of storage medium known in the art. In this regard, the memory 210 may be coupled to the processor 206 such that the processor 206 can read information from, and write information to, the memory 210. Alternatively, the memory 210 may be integral to the processor 206. In accordance with one embodiment, one or more software modules may reside in the memory 210. In an exemplary embodiment, the memory 210 is utilized to store information associated with various wireless access devices or mobile devices associated with the wireless switch 106 in a database 214.

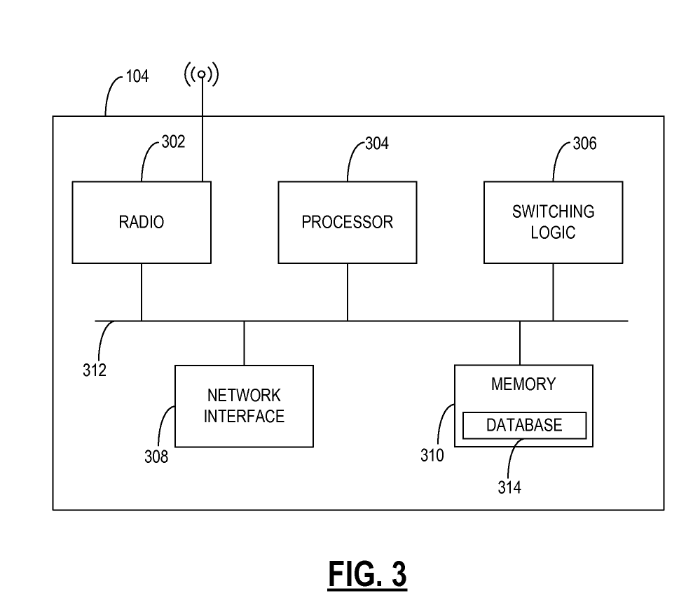

Referring to FIG. 3, in an exemplary embodiment, a block diagram illustrates is a schematic representation a wireless access device 104 suitable for use in a network, such as in the wireless network 100 of FIG. 1. In an exemplary embodiment, the wireless access device 104 may include, without limitation: a wireless radio 302, a processor 304, switching logic 306, a network interface 308, and a suitable amount of memory 310. In general, the wireless access device 104 may be referred to as an access point whereas the wireless access device 102 is referred to as an access port. The elements of the wireless access device 104 may be interconnected together using a bus 312 or another suitable interconnection arrangement that facilitates communication between the various elements of the wireless access device 104. It should be appreciated that FIG. 3 depicts the wireless access device 104 in an oversimplified manner, and a practical embodiment may include additional components and suitably configured processing logic to support known or conventional operating features that are not described in detail herein.

The radio 302 enables wireless communication to a plurality of wireless clients, such as the mobile devices 110. The wireless access device 104 may include more than one radio 302, e.g., each wireless radio 302 can operate on a different channel (e.g., as defined in IEEE 802.11). In an exemplary embodiment, the wireless access device 104 contains intelligence and processing logic that facilitates centralized control and management of WLAN elements, including wireless client devices associated with wireless access device 104. In an exemplary embodiment, one wireless access device 104 can support any number of wireless client devices (limited only by practical considerations). Thus, the wireless access device 104 can serve multiple wireless access devices, which in turn can serve multiple mobile devices. The wireless access device 104 is suitably configured to transmit and receive data, and it can serve as a point of interconnection between a WLAN and a wired (e.g., Ethernet) network. In practice, the number of wireless access device 104 in a given network may vary depending on the number of network users and the physical size of the network.

The processor 304 can be any microprocessor, application specific integrated circuit (ASIC), field programmable gate array (FPGA), digital signal processor (DSP), any suitable programmable logic device, discrete gate or transistor logic, discrete hardware components, or combinations thereof that has the computing power capable of managing the radio 302 and the auxiliary components 306, 308, 310 of the device 104. In an exemplary embodiment, the switching logic 306, which may be partially or completely realized in the processor 304, represents processing logic and functionality associated with the data switching and communicating features of the wireless access device 104. The switching logic 306 may be configured to perform conventional operations that enable data traffic in the wireless network to be communicated between mobile devices, access devices, network infrastructure components, and network-based systems or applications. In an exemplary embodiment, the switching logic 306 and the processor 304 may be cooperatively configured to implement processing logic and functionality associated with the handling of TCP congestion control between the access device 104 and mobile devices 110, as described in greater detail below. The wireless access device 104 also includes the network interface 308 that provides an Ethernet interface (i.e., wired) or another radio (i.e., wireless) such that wireless access device 104 can communicate with an external network. For example in FIG. 1, the wireless access device 104 is communicatively coupled to the wireless switch 106. Alternatively, the wireless access device 104 could connect directly to the local network 112

In an exemplary embodiment, the memory 310 includes sufficient data storage capacity to support the operation of the wireless access device 104. Memory 310 may be realized as random access memory (RAM), flash memory, registers, a hard disk, a removable disk, or any other form of storage medium known in the art. In this regard, the memory 310 may be coupled to the processor 304 such that the processor 304 can read information from, and write information to, the memory 310. Alternatively, the memory 310 may be integral to the processor 304. In accordance with one embodiment, one or more software modules may reside in the memory 310. In an exemplary embodiment, the memory 310 is utilized to store information associated with various wireless access devices or mobile devices associated with the wireless access device 104 in a database 314. In an exemplary embodiment, the access device 104 can support one or more wireless data communication protocols that are also supported by the wireless network infrastructure. Any number of suitable wireless data communication protocols, techniques, or methodologies can be supported by access device 104, including, without limitation: RF; IrDA (infrared); Bluetooth; ZigBee (and other variants of the IEEE 802.15 protocol); IEEE 802.11 (any variation); IEEE 802.16 (WiMAX or any other variation); Direct Sequence Spread Spectrum; Frequency Hopping Spread Spectrum; cellular/wireless/cordless telecommunication protocols; wireless home network communication protocols; paging network protocols; magnetic induction; satellite data communication protocols; wireless hospital or health care facility network protocols such as those operating in the WMTS bands; GPRS; and proprietary wireless data communication protocols such as variants of Wireless USB. In an exemplary embodiment, the wireless access device 104 is preferably compliant with at least the IEEE 802.11 specification and configured to receive association requests.

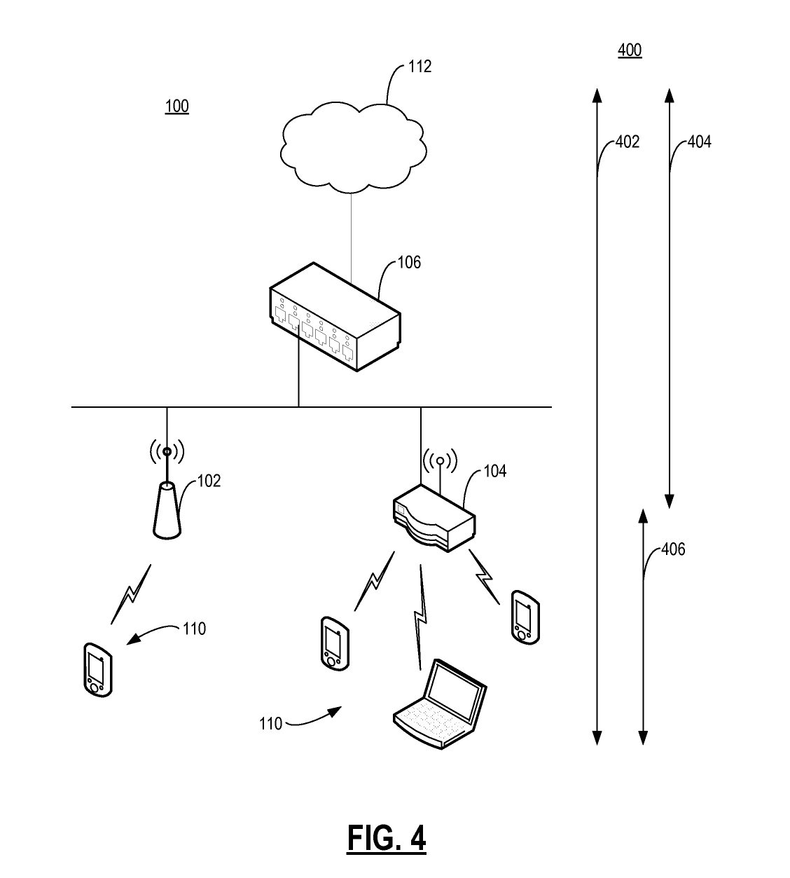

Referring to FIG. 4, in an exemplary embodiment, the wireless network 100 of FIG. 1 is illustrated with a chart showing TCP connections 400. The present invention provides optimization of TCP over WLAN links (e.g., IEEE 802.11, etc.). In particular, TCP provides the service of exchanging data directly between two network hosts, whereas Internet Protocol (IP) handles addressing and routing message across one or more networks. TCP provides reliable, ordered delivery of a stream of bytes from a program on one computer to another program on another computer. The TCP protocol uses dropped packets in order to detect network congestion and round-trip-time (RTT) and throughput to estimate when packets should be declared lost. As described herein, an IEEE 802.11 link in non-ideal conditions may have packet latency jitter and packet drop characteristics which interact badly with TCP, making the TCP socket back off much more than desirable, reducing throughput terribly. For example, a conventional TCP connection 402 is illustrated between a wired portion of the network 100 and a wireless portion of the network 100. Specifically, the wired portion includes the local network 112, the wireless switch 106, and one side of the wireless access devices 102, 104 (i.e., to the wireless switch 106 or the local network 112). The wireless portion includes one side of the plurality of wireless access devices 102, 104 to the mobile devices 110.

On the conventional TCP connection 402, poor IEEE 802.11 links between the plurality of wireless access devices 102, 104 and the mobile devices 110 tend to have momentary dropouts as the noise floor temporarily exceeds the signal strength. For example, this may cause one packet to be lost every once in a while, followed by a resumption of normal behavior. However the TCP connection 402 believes drops are caused by network congestion and it backs off as well as resending the lost packets which is unnecessary. That is, drops will happen regardless since the drop is determined by things unaffected by the TCP's throughput or back off. So TCP keeps “seeing congestion” and keeps backing off, and throughput slows to an unnecessary and frustrating crawl. Furthermore, in IEEE 802.11 power saving modes on the mobile devices 110, IEEE 802.11 latency experiences significant increases and jitter. This causes packets destined to the mobile device 110 to be buffered at the plurality of wireless access devices 102, 104 for hundreds of milliseconds thereby making that buffering the dominant part of the RTT messing with the lost-packet calculation.

In an exemplary embodiment of the present invention, the TCP connection 402 is split into two—a wired TCP connection 404 and a wireless TCP connection 406. Of note, the plurality of wireless access devices 102, 104 are in the middle of the TCP conversation, and by getting in the middle of the TCP connection 402, the plurality of wireless access devices 102, 104 have a chance of improving the situation for connections which are (mostly) to the mobile devices 110. For example, the wireless access devices 102, 104 are configured to terminate the wired TCP connection 404 at a local socket and to open a second TCP connection for the wireless TCP connection 406 to the mobile devices 110 (whether remote or the mobile device 110, depending on what direction the TCP connection is being made). Accordingly, the present invention can use a regular TCP socket for the wired TCP connection 404 to connect with the remote end in the local network 112, and a different TCP socket for the wireless TCP connection 406 with a customized congestion avoidance algorithm on the wireless side. In another exemplary embodiment, the wired TCP connection 404 and the wireless TCP connection 406 may be done without using two sockets, i.e. in-line.

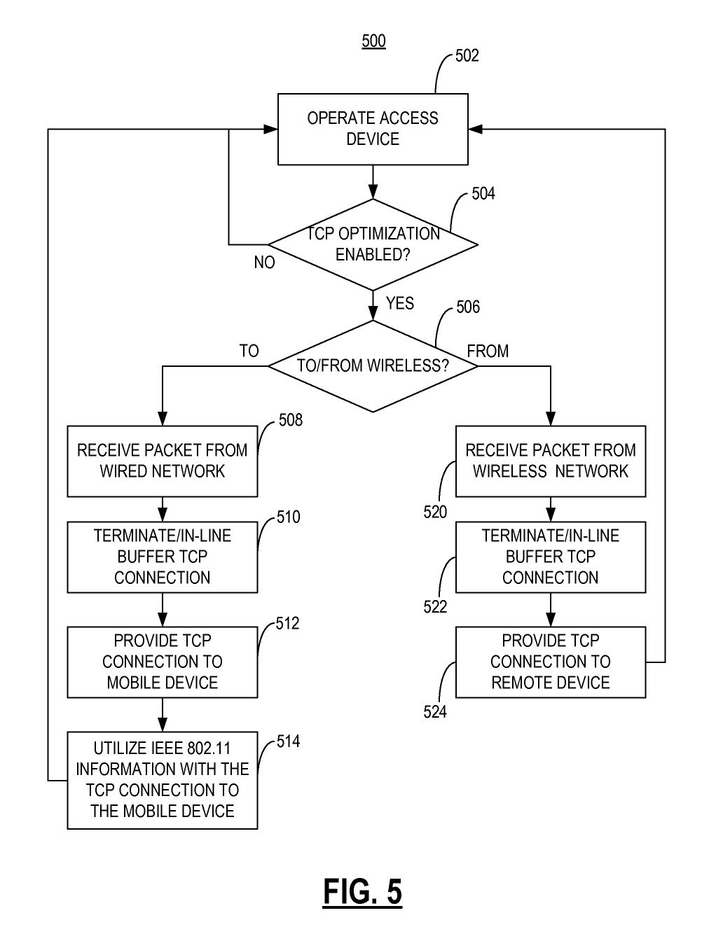

Referring to FIG. 5, in an exemplary embodiment, a flowchart illustrates a TCP optimization method 500. Specifically, the TCP optimization method 500 may be utilized to split the wired TCP connection 404 and the wireless TCP connection 406 in the network 100. The TCP optimization method 500 is configured to operate at the plurality of wireless access devices 102, 104. First, an access device is operated (step 502). As is shown in FIG. 4, the access device has a wireless side (to/from the mobile devices 110) and a wired side (to/from the local network 112 and/or the wireless switch 106). The TCP optimization method 500 provides a mechanism to provide the wired TCP connection 404 and the wireless TCP connection 406. In an exemplary embodiment, TCP optimization is a user-selectable setting (step 504). If the TCP optimization is disabled, then the access device operates normally, e.g. with the conventional TCP connection 402 (back to step 502). If the TCP optimization is enable, then the TCP optimization method 500 determines for each packet the direction (step 506).

Transmitting to the mobile device, the access device receives a packet from the wired network (step 508). The access device is configured to terminate or perform in-line buffering/processing to separate the TCP connection between the wired and the wireless side (step 510). The access device, i.e. the wireless access devices 102, 104, is configured to separate the TCP connection, i.e. the wired TCP connection 404 and the wireless TCP connection 406, providing a TCP connection to the mobile device (step 512). This may be done via two sockets, one each of the wired TCP connection 404 and the wireless TCP connection 406, or in-line. Using two sockets, the access device is configured to terminate the wired TCP connection 404 on one socket and to relay data to the wireless TCP connection 406 on another socket. Getting into the middle of the TCP conversation does not have to do be done with two sockets. It can be done in-line as well through buffering and resending at the access device. Here, the access device is configured to modify the incoming wired TCP connection 404 to demarcate it from the wireless TCP connection 406 on the same socket. In an exemplary embodiment, the in-line embodiment may be turned on or off on-the-fly. Here, the in-line embodiment may be used only as required based on the wireless conditions thereby reducing the overall load on the access device. As described herein, the present invention hides from the remote side of the TCP connection (which is presumed over good, wired networks) from the lossy wireless side. That way the remote side runs smoothly with its standard TCP algorithm (Reno or BIC being common) and the access device takes care of running TCP over the wireless side.

Specifically, the TCP optimization method 500 allows for a different TCP algorithm on the wired side and the wireless side. Thus, the wireless side may utilize a more suitable algorithm and hide the wireless link from the overall connection. For example, a TCP socket's congestion algorithm may be pluggable (e.g. new ones can be added at runtime in a Linux software implementation), and can be selected on-the-fly. The wireless side's congestion avoidance algorithm can be the out-of-the-box Veno or Westwood[+]. TCP has a variety of congestion avoidance algorithms which determine exactly how the TCP socket reacts to packet losses and RTT changes. Most are developed for wired networks' characteristics, including ones typically used by the access device. The Westwood[+] and Veno congestion control algorithms provide improvements on lossy networks like IEEE 802.11. However use of these algorithms requires that the sending end use the same algorithms, which is not the default on any operating system, so there are very few senders using it.

Additionally, the present invention utilizes the fact that the access device to mobile device connection tends to be the only hop in that TCP connection's path (that is, the wireless client tends not to be a bridge or router itself, or if it is, the IEEE 802.11 link is the limiting factor for both bandwidth and loss), the present invention may couple the mobile device's connection information to the TCP algorithm (step 514). For example, IEEE 802.11 ACKs may be used by the access device to indicate that the packet has been delivered to the mobile device's radio Media Access Controller (MAC). Since after that there are typically no drop points inside the mobile device's software, an IEEE 802.11 ACK is as good as a TCP ACK. The TCP ACK is still needed to back off sending when the window is exceeded, but if the previous window would permit another packet, the IEEE 802.11 ACK is enough to trigger sending it. In addition, no back off is needed at the TCP layer. It can blindly hand the next set of packets to the IEEE 802.11 radio as soon as the previous packet has been IEEE 802.11 acknowledged and the TCP window allows.

The IEEE 802.11 radio has a scheduler which determines when the next packet is sent on the air, given the power save state of the mobile device, what other packets are on the air, and whatever else is going on that radio (Quality of Service (QoS), airtime fairness scheduling, etc). Thus the TCP socket is not trying to guess at the congestion in the path. The TCP socket knows the congestion because the entire path is visible to it from feedback from the radio after each packet is transmitted or retried. That is, IEEE 802.11 queuing may effectively substitute for TCP congestion scheduling algorithm and IEEE 802.11 ACKs may effectively substitute for TCP ACKs. Note, TCP ACKs carry more information than IEEE 802.11 ACKs. In an exemplary embodiment, the IEEE 802.11 ACKs may be modified to include all of the standard information in IEEE 802.11 ACKs plus some state information kept on the access device plus some guesses about how things are going on the mobile device. More specifically, a TCP ACK needs to carry a forward sequence number, an ACK sequence number (both of which are available from snooping the client's TCP communication), a forward TCP timestamp (synthesized locally as the TCP session is intercepted), an echoed TCP timestamp (available from snooping TCP packets from the wired side), and a TCP window, which may be determined at by combining the client's last TCP window advertisement plus accounting for how much data has been sent past the TCP window plus a correction for how well the data has been consumed (optional).

Receiving from the mobile device, the access device receives a packet from the wireless network (step 520). Here, the TCP optimization method 500 performs substantially the same steps as transmitting to the mobile device. Specifically, the access device receives a packet from the wireless network (step 522). The access device is configured to terminate or perform in-line buffering/processing to separate the TCP connection between the wired and the wireless side (step 520). The access device, i.e. the wireless access devices 102, 104, is configured to separate the TCP connection, i.e. the wired TCP connection 404 and the wireless TCP connection 406, providing a TCP connection to a remote device (step 524). The terminating/in-line buffering and providing the TCP connection here may be substantially the same as described above.

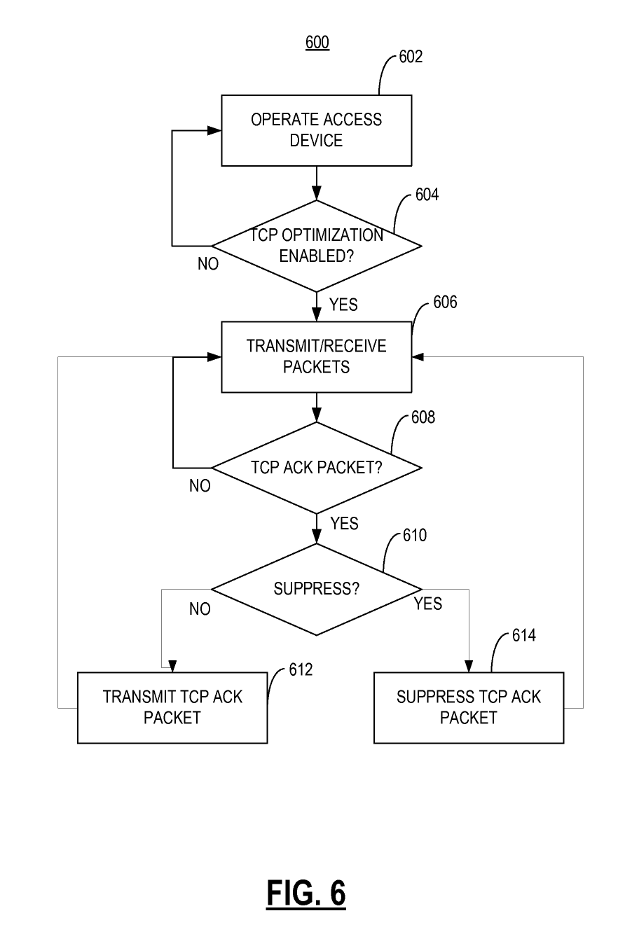

Referring to FIG. 6, in an exemplary embodiment, a flowchart illustrates a TCP optimization method 600 over a single hop WLAN network. Specifically, the TCP optimization method 600 may be utilized over the TCP connection 402 between the plurality of wireless access devices 102, 104 and the mobile devices 110. Also, the TCP optimization method 600 may be utilized over the wireless TCP connection 406 in the network 100. The TCP optimization method 600 is configured to suppress most of the TCP ACKs over the link between the plurality of wireless access devices 102, 104 and the mobile devices 110. First, an access device is operated (step 602). As is shown in FIG. 4, the access device has a wireless side (to/from the mobile devices 110) and a wired side (to/from the local network 112 and/or the wireless switch 106). In an exemplary embodiment, TCP optimization is a user-selectable setting (step 604). If the TCP optimization is disabled, then the access device operates normally (back to step 602). If the TCP optimization is enable, then the TCP optimization method 600 operates with the plurality of wireless access devices 102, 104 transmitting and receiving packets with the mobile devices 110 (step 606). If a TCP ACK packet is received (step 608), the TCP optimization method 600 determines whether or not to suppress the TCP ACK packet (step 610).

Specifically, the TCP optimization method 600 is performed over a single hop WLAN network to suppress most of the TCP ACK packets over the hop during normal operating conditions. As described herein, normal operating conditions may include when packet transmissions over the single hop are going well such as the TCP window is not getting low. If the TCP optimization method 600 determines that the TCP ACK packet should not be suppressed, then the TCP ACK packet is transmitted (step 612). Conversely, if the TCP optimization method 600 determines that the TCP ACK packet should be suppressed, the TCP ACK packet is suppressed (step 614). For example, suppressing the TCP ACK packet may include at the plurality of wireless access devices 102, 104 simply dropping the TCP ACK packet and not transmitting it to the mobile devices 110. Advantageously, the TCP optimization method 600 provides the efficiency of streaming TCP data to mobile clients approaching that of streaming with User Datagram Protocol (UDP), but still retains the non-lossyness and ordering of TCP.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention and are intended to be covered by the following claims.

What is claimed is:

1. A Transmission Control Protocol (TCP) optimization method, comprising:
operating a wireless access device communicatively coupled to a mobile device and a wired network; and
at the wireless access device, splitting TCP connections between the mobile device and the wired network into a wireless TCP connection and a wired TCP connection.

2. The TCP optimization method of claim 1, further comprising:
selectively enabling TCP connection optimization at the wireless access device, wherein the splitting TCP connections between the mobile device and the wired network is performed if the TCP connection optimization is selectively enabled.

3. The TCP optimization method of claim 1, wherein the splitting TCP connections between the mobile device and the wired network at the wireless access device comprises:
terminating the TCP connection at a local socket; and
opening up another TCP connection on another socket.

4. The TCP optimization method of claim 1, wherein the splitting TCP connections between the mobile device and the wired network at the wireless access device comprises:
performing an in-line separation by buffering and resending between the wireless TCP connection and the wired TCP connection.

5. The TCP optimization method of claim 4, further comprising:
selectively enabling the in-line separation based upon conditions associated with a wireless link between the wireless access device and the mobile device.

6. The TCP optimization method of claim 1, further comprising:
utilizing a first TCP congestion control algorithm on the wired TCP connection; and
utilizing a second TCP congestion control algorithm on the wireless TCP connection.

7. The TCP optimization method of claim 6, wherein the first TCP congestion control algorithm is different from the second TCP congestion control algorithm.

8. The TCP optimization method of claim 6, wherein the second TCP congestion control algorithm comprise either TCP Westwood+ or Veno.

9. The TCP optimization method of claim 1, further comprising:
utilizing wireless local area network connection information between the mobile device and the wireless access device with the wireless TCP connection.

10. The TCP optimization method of claim 9, wherein the utilizing wireless local area networking connection information comprises utilizing queuing associated with wireless local area networking in place of a TCP congestion control algorithm and utilizing wireless local area networking acknowledgements in place of TCP acknowledgements.

11. A wireless access device, comprising:
a communication interface configured to communicate with one or more mobile devices wirelessly and with a wired network; and
a processor coupled to the communication interface, wherein, for one or more Transmission Control Protocol (TCP) connections between one of the one or more mobile devices and the wired network, the processor is configured to split each of the one or more TCP connections into a wireless TCP connection and a wired TCP connection.

12. The wireless access device of claim 11, wherein, to split each of the one or more TCP connections, the processor is configured to utilize separate sockets for the wireless TCP connection and the wired TCP connection.

13. The wireless access device of claim 11, wherein, to split each of the one or more TCP connections, the processor is configured to perform an in-line separation by buffering and resending between the wireless TCP connection and the wired TCP connection.

14. The wireless access device of claim 13, wherein the processor is configured to selectively enable the in-line separation based upon conditions associated with a wireless link between the wireless access device and the mobile device.

15. The wireless access device of claim 11, wherein the processor is configured to utilize a first TCP congestion control algorithm on the wired TCP connection and a second TCP congestion control algorithm on the wireless TCP connection.

16. The wireless access device of claim 15, wherein the first TCP congestion control algorithm is different from the second TCP congestion control algorithm.

17. The wireless access device of claim 15, wherein the second TCP congestion control algorithm comprise either TCP Westwood+ or Veno.

18. The wireless access device of claim 11, wherein the processor is configured to utilize wireless local area network connection information related to a wireless link to one of the one or more mobiles device with the wireless TCP connection.

19. The wireless access device of claim 18, wherein, to utilize wireless local area network connection information, the processor utilizes queuing associated with wireless local area networking in place of a TCP congestion control algorithm and wireless local area networking acknowledgements in place of TCP acknowledgements.

20. A network, comprising:
a wired network;
a wireless network; and
a wireless access device communicatively coupling the wired network and the wireless network therebetween;
wherein the wireless access device is configured to implement Transmission Control Protocol (TCP) optimization algorithm between the wired network and the wireless network.
